(19) United States
(12) Patent Application Publication
(10) Pub. No.: US 2025/0307950 A1
(43) Pub. Date: Oct. 2, 2025

(54) GAMING ESTABLISHMENT MARKER AUDIT REPORTING AND ADJUSTMENTS

(71) Applicant: IGT, Las Vegas, NV (US)

(72) Inventors: Jeffery Shepherd, Reno, NV (US); Kevin Higgins, Reno, NV (US)

(21) Appl. No.: 18/624,883

(22) Filed: Apr. 2, 2024

(51) Int. Cl. G06Q 40/12; G07F 17/32

(52) U.S. Cl. CPC G06Q 40/12; G07F 17/3244

(57) ABSTRACT

Systems and methods that enable reporting of and, if applicable, adjustments to an audit of a gaming establishment marker provided to a user in association with a transfer of funds between a gaming establishment account and a gaming establishment credit system.

### BACKGROUND

In various embodiments, the systems and methods of the present disclosure enable reporting of and, if applicable, adjustments to an audit of a gaming establishment marker provided to a user in association with a transfer of funds between a gaming establishment account and a gaming establishment credit system.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIGS. 1A and 1B are example configurations of the architecture of a plurality of different components of different embodiments of the system of the present disclosure.

FIG. 2 is an example configuration of the architecture of a plurality of different components of the system of the present disclosure operating together to enable an audit in association with a gaming establishment marker being activated and a corresponding transfer of funds to a gaming establishment account.

FIG. 3 is a flow chart of an example process for operating a system including various components that operate to audit data associated with an activation of a gaming establishment marker and a corresponding transfer of funds to a gaming establishment account.

### DETAILED DESCRIPTION

In various embodiments, the systems and methods of the present disclosure enable reporting of and, if applicable, adjustments to an audit of a gaming establishment marker provided to a user in association with a transfer of funds between a gaming establishment account and a gaming establishment credit system.

In certain embodiments, in association with the activation of an amount of funds drawn against a gaming establishment marker and transfer of such funds between a gaming establishment credit system and a gaming establishment account, the system of the present disclosure operates to audit data associated with such a transfer to ensure that the one or more transactions associated with the gaming establishment marker correspond with one or more transactions associated with the gaming establishment account. That is, given the flow of funds between a gaming establishment credit system and a gaming establishment fund management system, the system audits the flow of funds between these two systems to ensure that no funds are manufactured or lost between the two systems due to software defects or insider attacks.

More specifically, since the activation of a gaming establishment marker at a gaming establishment device includes a transfer of funds from a gaming establishment credit system to a gaming establishment account maintained by a gaming establishment fund management system and then a transfer of such funds from the gaming establishment account to the gaming establishment device, the system employs a distinct marker audit function service to audit funds transferred in association with the activation of the gaming establishment marker and reconcile such funds against transactions recorded by the gaming establishment credit system and the gaming establishment fund management system. For example, since the activation of a marker at an electronic gaming machine (i.e., a gaming establishment device) involves funds associated with the marker first being transferred to a cashless wagering account and then being transferred to the electronic gaming machine, one or more computing components operating as the marker audit function service access one or more databases to determine zero, one or more transactions associated with the cashless wagering account and zero, one or more transactions associated with the gaming establishment credit system. In this example, such components operating as the marker audit function service then audit such transactions to determine whether or not the transactions associated with the cashless wagering account track the transactions associated with the gaming establishment credit system. As such, since the activation of a gaming establishment marker at a gaming establishment device results in an amount of funds flowing through one or more intermediate destinations before being transferred to the gaming establishment device, the system independently audits these marker transfers to ensure that these transactions are properly accounting for and if not, how and why any breakdowns in such fund flows occurs.

In certain embodiments, in association with the movement of funds from a gaming establishment credit system to a gaming establishment account and then to a gaming establishment device and the corresponding audit of such transactions, the system of the present disclosure determines if any discrepancies or variances exist between different data sets associated with these different transactions. In certain such embodiments, if such discrepancies exist, the system determines one or more available actions, such as enabling a creation of a new record reflecting a change of one or more transactions (to account for the determined discrepancy) and/or reporting such discrepancies to certain interested parties (whom may take further action if such discrepancies are indicative of nefarious activity). As such, the system enables the reconciliation of transaction data from different data sets and further enables, as appropriate, one or more actions to be undertaken based on the particular discrepancy or variance that exists between such different data sets.

Accordingly, certain embodiments of the present disclosure enable a transfer of funds from a gaming establishment credit system to a gaming establishment account (e.g., a cashless wagering account) and then to a balance of a gaming establishment device (e.g., an electronic gaming machine) without the use of cash and without losing any auditing functionality otherwise associated with gaming establishment markers. That is, since certain gaming establishment patrons are uncomfortable venturing into a gaming establishment with large amounts of cash, the system enables a user access to an amount of funds from a gaming establishment marker without the need to handle cash. Such reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based transactions and cashless ticket voucher-based transactions (e.g., protecting patrons from using forms of currency and/or paper cashless ticket vouchers that act as transmission vehicles for contagions), and benefits the gaming establishment by reducing the use of certain kiosks that accept cash (e.g., reducing the wear and tear on such devices and prolonging the operational life on these devices).

Additionally, by reducing the amount of cash transactions in a gaming establishment via enabling the use of gaming establishment markers while retaining audit functionality, the system reduces or eliminates human errors which often occur when cash is distributed at gaming establishment interfaces, such as casino desks and/or cashless ticket vouchers are purchased with an amount of cash at gaming establishment interfaces, such as casino desks. Specifically, eliminating gaming establishment personnel from distributing cash and/or issuing ticket vouchers in exchange for amounts of cash not only protects the user (if the gaming establishment personnel provides the gaming establishment patron a lower amount of cash and/or a lower valued cashless ticket voucher than the patron deserves) but also protects the gaming establishment (if the gaming establishment personnel inadvertently or fraudulently provides the patron a higher amount of cash and/or or a higher valued cashless ticket voucher than the patron deserves). As such, the system of the present disclosure provides an alternative, non-cash-based and non-ticket voucher-based option for a gaming establishment patron to access funds at a gaming establishment device while still tracking, for auditing purposes, the pathway of such funds from the gaming establishment credit system to the gaming establishment device and potentially back to the gaming establishment credit system.

In various embodiments, the present disclosure is directed to a system including or otherwise in communication with various components and/or sub-systems that operate together to cause a transfer and associated audit of an amount of funds from a gaming establishment credit system to a gaming establishment device, such as an electronic gaming machine with the employment of a gaming establishment account, independent of any cash and independent of any cashless ticket vouchers (e.g., an anonymous bearer instrument associated with an amount of funds and redeemable for cash via a kiosk, a cashier and/or game play on a gaming establishment device). In these embodiments, the collection of components that are part of the system (or otherwise operate with one or more components of the system) facilitate an auditable transfer of funds from a gaming establishment credit system to a gaming establishment account and then to a gaming establishment device.

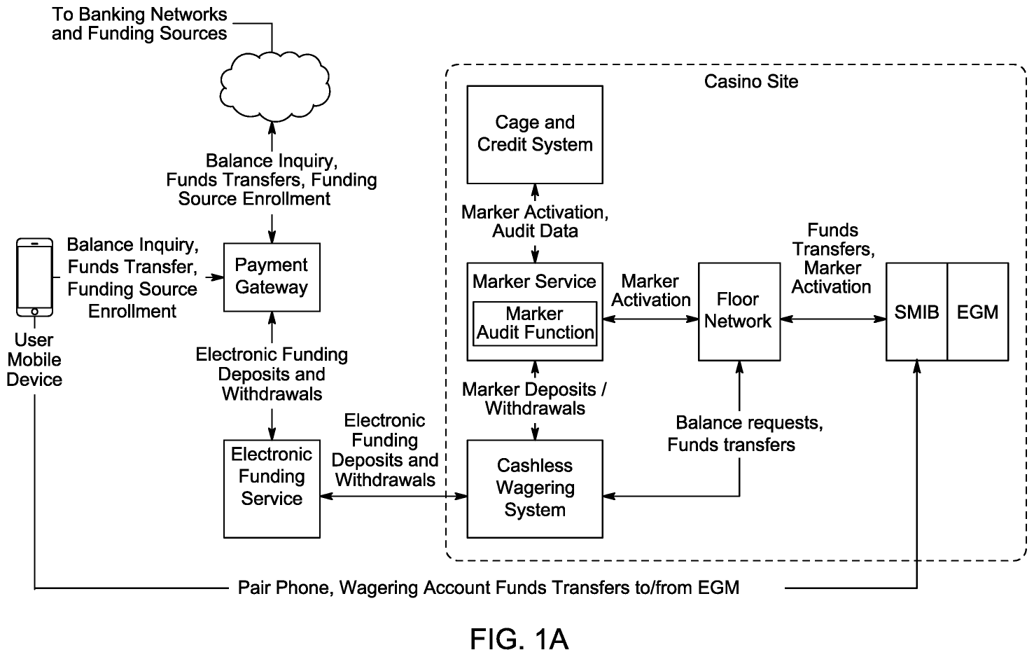

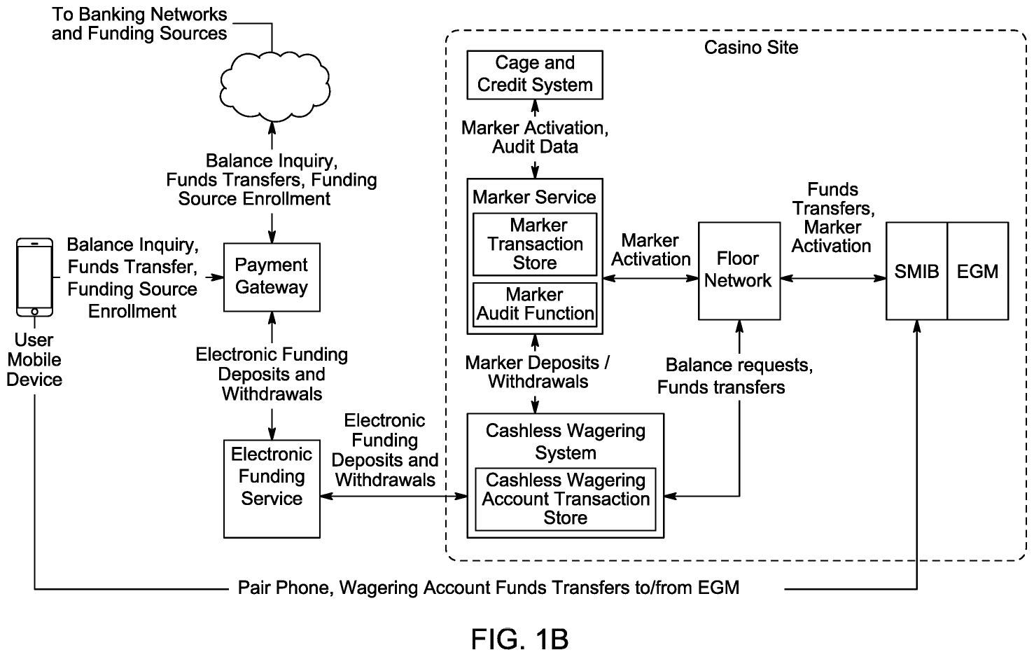

In various embodiments, the system includes or is otherwise in communication with a payment gateway operable to interface with a banking network to communicate with one or more servers of one or more financial institutions that maintain one or more financial institution accounts and implement zero, one or more financial institution protocols, such as banking protocols. In such embodiments, the system includes a payment gateway operable with a banking network and one or more external funding sources (e.g., financial institutions) which maintain one or more external accounts (e.g., financial institution accounts) for a user to enable certain actions, including, but not limited to, balance inquiries, funding source enrollments and/or fund transfers. For example, as seen in FIGS. 1A and 1B, the system includes one or more servers operating as a payment gateway in communication with a network of one or more servers of one or more banks or other financial institutions (i.e., the banking network and funding sources) which operate to electronically transfer funds from one or more accounts maintained at such banks or financial institutions to an electronic gaming machine (“EGM”) via a series of one or more intermediaries operating directly or indirectly with the payment gateway. As also seen in FIGS. 1A and 1B, the payment gateway is in communication with a mobile device which enables a user to conduct balance inquiries, request funding source enrollments and/or request fund transfers from one or more external funding sources. In different embodiments, the accounts of the external funding sources include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts).

In certain embodiments, the system includes or is otherwise in communication with an electronic funding service operable with the payment gateway. In these embodiments, the electronic funding service enables for a single entry point for all external funding transactions and if necessary, operates to disambiguate between destination sites of funds transferred from one or more external funding sources. For example, as seen in FIGS. 1A and 1B, the system includes one or more servers operating as an electronic funding service in communication with one or more servers of the payment gateway to enable certain actions, including, but not limited to, balance inquiries, and/or fund transfers.

In various embodiments, the system includes or is otherwise in communication with a gaming establishment fund management system that maintains one or more gaming establishment accounts. In certain such embodiments, the system includes or is otherwise associated with one or more cashless wagering systems. Each cashless wagering system is associated with or otherwise maintain one or more cashless wagering accounts. In these embodiments, a user utilizes a mobile device application running on a mobile device and/or a physical instrument (e.g., a smart card or a user issued magnetic striped card which the user utilizes via inserting the card into a component of a gaming establishment patron management system associated with a gaming establishment device) to facilitate the electronic transfer of any funds between this cashless wagering account and a gaming establishment device, such as a component of a gaming table and/or an EGM. For example, as seen in FIGS. 1A and 1B, the system includes one or more servers operating as a cashless wagering system that maintains a cashless wagering account (not shown) and which is in communication with the electronic funding service. In certain such embodiments, the gaming establishment fund management system additionally operates with a gaming establishment device management system to direct funds from one or more gaming establishment accounts to the appropriate gaming establishment device. As further seen in FIGS. 1A and 1B, the cashless wagering system is also in communication with one or more components of a gaming establishment floor management system (i.e., the floor network) to enable certain actions, including, but not limited to, balance inquiries, and/or fund transfers.

In certain embodiments, the system additionally or alternatively includes or is otherwise in communication with another cashless wagering system that maintains another cashless wagering account utilized to place one or more sporting event wagers and/or wagers placed remote from a gaming establishment device. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this cashless wagering account and a credit balance accessible to wager on sporting events and/or games of chance (or games of skill) remote from a gaming establishment device.

In certain embodiments, the system includes or is otherwise in communication with one or more credit systems which each issue the user one or more lines of credit or markers. For example, as seen in FIGS. 1A and 1B, the system includes a gaming establishment credit system (i.e., the cage and credit system) to facilitate the access of an amount of funds via one or more lines of credits or markers. These lines of credit or markers are accessible to facilitate a transfer of funds from the line of credit issued by the credit system to, either directly or indirectly through a cashless wagering account, a credit balance of a gaming establishment device, such as an EGM and/or a gaming table. In certain embodiments (not shown), the system also includes or is otherwise in communication with one or more credit reporting/credit risk systems. These credit reporting and risk systems monitor and report on a credit rating and status of one or more accounts maintained for the user at various funding sources, such as various financial institutions.

In certain embodiments, the system includes or is otherwise in communication with a marker service operable with the gaming establishment credit system and the gaming establishment fund management system to coordinate the employment of one or more markers. In these embodiments, the marker service operates with the gaming establishment credit system to facilitate the activation of one or more markers and communicate audit data associated with such activated markers. In these embodiments, the marker service also operates with the gaming establishment fund management system to coordinate marker deposits and withdrawals from one or more gaming establishment accounts maintained by the gaming establishment fund management system. In such embodiments, the marker service further operates with a gaming establishment device management system to direct funds activated from one or more markers to the appropriate gaming establishment device. For example, as seen in FIGS. 1A and 1B, the system includes one or more servers operating as marker service in communication with the cage and credit system to enable certain actions, including, but not limited to, marker activations and audit data communications. As also seen in FIGS. 1A and 1B, the marker service is also in communication with a cashless wagering system to enable certain actions, including, but not limited to, marker deposits and withdrawals. As further seen in FIGS. 1A and 1B, the marker service is also in communication with one or more components of a gaming establishment floor management system (i.e., the floor network) to enable certain actions, including, but not limited to, marker activations and funds transfers.

In certain embodiments, the system includes or is otherwise associated with a marker audit function service that performs audits of markers activated in view of gaming establishment account balance movements and offers the tools to adjust certain data when variances are discovered. For example, as seen in FIG. 1A, the marker service includes one or more servers operating as a marker audit function service operable to audit activations of markers and reconcile such marker activations against transfers of funds into and out from one or more cashless wagering accounts. In certain embodiments, the system is in communication with a separate and distinct marker audit function service that performs audits of markers activated in view of gaming establishment account balance movements and offers the tools to adjust certain data when variances are discovered.

In certain embodiments, the system includes or is otherwise in communication with one or more gaming establishment patron management systems that, amongst other tasks, monitor activities at various points of contact associated with a gaming establishment and provides rewards, such as redeemable player tracking points, in association with such activities. In these embodiments, one or more components of the gaming establishment patron management system that are associated with an individual gaming establishment device operate with the gaming establishment device management system to facilitate the transfer of funds from one or more gaming establishment accounts to that individual gaming establishment device. For example, as seen in FIGS. 1A and 1B, the system employs a slot machine interface board (“SMIB”) (i.e., a component of a gaming establishment patron management system) associated with an EGM and in communication with one or more components of a gaming establishment floor management system (i.e., the floor network) to enable certain actions, including, but not limited to, balance inquiries, marker activation reporting and/or fund transfers. In these embodiments, one or more components of the gaming establishment patron management system that are associated with an individual gaming establishment device also operate with a mobile device of a user to enable the component of the gaming establishment patron management system to identify, to the payment gateway, the gaming establishment device that will receive the funds from the external funding source. For example, as seen in FIGS. 1A and 1B, the system employs the SMIB associated with the EGM to pair with a mobile device that is in communication with the payment gateway to enable the payment gateway (and one or more intermediate components) to identify the appropriate EGM to transfer funds to.

In certain embodiments, the system includes or is otherwise in communication with a gaming establishment device accounting system operable to monitor transactions occurring in association one or more of the components of (or otherwise operable with) the system of the present disclosure. In certain such embodiments, the gaming establishment device accounting system includes the marker audit function service that performs audits of markers activated in view of gaming establishment account balance movements and offers the tools to adjust certain data when variances are discovered.

In certain embodiments, the system utilizes one mobile device application to interact with the different components of the system to, amongst other actions, access funds maintained in the different external accounts associated with the user, activate one or more markers, and/or transfer funds between one or more gaming establishment accounts and one or more gaming establishment devices. In certain embodiments, the system utilizes multiple mobile device applications to interact with the different components of the system to, amongst other actions, access funds maintained in the different external accounts associated with the user, activate one or more markers, and/or transfer funds between one or more gaming establishment accounts and one or more gaming establishment devices. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

While illustrated as certain systems, sub-systems or components being in communication with other systems, sub-systems or components, any system, sub-system or component of the present disclosure can be in communication with one or more other systems, sub-systems or components to facilitate, as appropriate, access funds maintained in the different external accounts associated with the user, activate one or more markers, and/or transfer funds between one or more gaming establishment accounts and one or more gaming establishment devices. For example, while the payment gateway is illustrated in FIGS. 1A and 1B as being in communication with a banking network and one or more external funding sources, in different embodiments, any system, sub-system or component of the present disclosure can be in communication with a banking network and one or more external funding sources. In another example, while the gaming establishment device management system (e.g., the floor network) is illustrated in FIGS. 1A and 1B as being in communication with the marker service and the SMIB, in different embodiments, any system, sub-system or component of the present disclosure can be in communication with the marker service and/or the SMIB.

Moreover, in certain embodiments, two or more of the systems, sub-systems and components of the present disclosure may be combined into a single system, sub-system or component. For example, while the payment gateway and the electronic funding service are illustrated as separate components, the payment gateway and the electronic funding service may be combined into a single component operable to interface with the banking networks and funding sources as well as the gaming establishment fund management system (e.g., the cashless wagering system) to facilitate the transfer of funds from an external account to a gaming establishment account. In another example, while the gaming establishment credit system (e.g., the cage and credit system) and the marker service are illustrated as separate components, the gaming establishment credit system and the marker service may be combined into a single component operable to interface with the gaming establishment fund management system (e.g., the cashless wagering system) as well as the gaming establishment device management system (e.g., the floor network) to facilitate the activation of a marker and the subsequent auditing of such an activation. In another example, while certain audit functions are performed by the marker audit function service of FIG. 1, part or all of such audit functions may be performed by a gaming establishment device accounting system and/or any other component of (or operable with) the present disclosure.

It should be appreciated that while illustrated in FIGS. 1A and 1B as a mobile device running a mobile device application being in communication with certain components of the present disclosure to facilitate the transfer of funds from an external account to a gaming establishment device, facilitate that activation of a marker and/or facilitate a transfer of funds between a gaming establishment account, such as a cashless wagering account, and a credit balance of an EGM (and/or a credit balance of a gaming table component associated with a gaming table), any suitable device, such as, but not limited to, a kiosk, a gaming establishment device (e.g., an interface of a gaming device, such as an EGM, or an interface of a non-gaming device, such as a retail point-of-sale terminal associated with a gaming establishment), an externally controlled interface displayed by a gaming establishment device (e.g., a remote host controlled service window displayed by an EGM), a component of a gaming establishment patron management system, such as a player tracking unit, and/or a gaming establishment interface, may be in communication with certain components of the present disclosure to facilitate the transfer of funds from an external account to a gaming establishment device, facilitate that activation of a marker and/or facilitate a transfer of funds between a gaming establishment account, such as a cashless wagering account, and a credit balance of an EGM (and/or a credit balance of a gaming table component associated with a gaming table).

It should be further appreciated that while illustrated in FIGS. 1A and 1B as funds accessed from an external funding source and/or funds activated from a gaming establishment marker being transferred (directly or indirectly through a gaming establishment account, such as a cashless wagering account) to an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)), in different embodiments, funds accessed from an external funding source and/or funds activated from a gaming establishment marker may be transferred to any suitable non-EGM gaming establishment device operable to receive funds, such as, but not limited to, a kiosk or a retail point-of-sale terminal associated with a gaming establishment.

In certain embodiments, the system enables a transfer of funds between different external accounts and different gaming establishment components as well as activations of markers following by a transfer of funds associated with the activated marker to different gaming establishment components to enable different gaming activities and/or non-gaming activities. In these embodiments, the system employs a service for interfacing with the various components to facilitate balance inquiries and the transfer of funds. In certain embodiments, such a service collects data from various components and utilizes such collected data to provide a singular view of the balances (or a plurality of singular views of different groupings of balances) available. In certain embodiments, such a service additionally or alternatively provides facilities to enforce rules and/or limitations including, but are not limited to, jurisdictional controls, self-imposed limits, state governmental controls and federal governmental controls, wherein the system provides the logic to determine how, and how much, to transfer to satisfy a request for funds while staying within the confines of such rules. In certain embodiments, as described in more detail below, such a service additionally or alternatively tracks and coalesces and audits transaction history of the interconnected components of the system. In these different embodiments, all transactions within the system have a “master” transaction record that ties all of the various fund transfers to a single initiating funds transfer.

In various embodiments, prior to conducting audits in association with one or more markers, the system enables a user to establish a marker with a gaming establishment credit system. In certain such embodiments, this includes a user applying for a marker (with or without presenting a check or other bank account information in the event the marker is not paid back by the user) and the credit system approving the marker for up to a set amount of funds.

In certain embodiments, to apply for a marker, the system enables a user to utilize an interface, such as a mobile device application being executed by a mobile device, a website accessed from a browser, a kiosk and/or a service window displayed by EGM (or other gaming establishment device), to attempt to complete the application through one or more interactive forms. For example, as part of applying for a marker, the user makes one or more inputs via an interface to provide certain user identifying information (such as, but not limited to, name, address, birthdate, state of birth, additional address details, a social security number and/or a mother's maiden name) and/or certain external account identifying information (such as, but not limited to, an identification of a funding source, and/or an external account number) in the event the marker is not paid back by the user.

In certain embodiments, as part of applying for a marker, the system determines zero, one or more security measures to invoke in association with one or more (or each) transaction that involves funds accessed via the marker. In these embodiments, to prevent unauthorized access to the funds associated with such a marker, the system applies such determined security measures in association with one or more (or each) transaction that attempts to access funds via the marker. In certain embodiments, as part of applying for a marker, the system determines one or more controls or restrictions to associate with the marker wherein if such controls are violated, the system invokes one or more security measures. In these embodiments, to balance the need to prevent unauthorized access to the funds associated with a marker against the need to provide a frictionless experience for users, the system dynamically employs one or more security measures such that certain transactions that trigger the need to employ enhanced security measures and certain transactions that do not trigger the need to employ enhanced security measures. It should be appreciated that an enhanced security measure includes any form of security that was not otherwise associated with the transaction prior to the determination that the nature of the transaction warranted an additional degree of protection to combat any attempted fraud associated with the transaction. For example, if a user is required to enter a personal identification number (“PIN”), provide a signature and/or present a biometric identifier for each attempted transfer of funds from a marker regardless of any determination that the nature of the transaction warrants any additional degree of protection to combat any attempted fraud associated with the transaction, such a PIN, signature and/or biometric identifier would not qualify as an enhanced security measure. In another example, if a user is not required to enter a PIN, provide a signature and/or present a biometric identifier for each attempted transfer of funds from a marker but following a determination that the nature of the transaction warrants requiring the user to enter a PIN, provide a signature and/or present a biometric identifier an as an additional degree of protection to combat any attempted fraud associated with the transaction, such a PIN, signature and/or biometric identifier would qualify as an enhanced security measure.

Following the establishment of the marker, the system enables the user to utilize any suitable interface to view information about one or more available markers (e.g., an available amount of funds associated with the marker and/or an amount of funds associated with the marker previously accessed) as well as the balance of zero, one or more gaming establishment accounts.

In addition to enabling the user to view information about one or more available markers, the system enables the user to activate all or part of the available amount of funds associated with an available marker. That is, the system enables the user to activate a marker wherein, in certain embodiments as described below, the accessed amount of funds are first transferred to a gaming establishment account associated with the user, such as the user's cashless wagering account and then transferred to a balance of a gaming establishment device. In these embodiments, the system enables the user to make one or more inputs regarding the requested access to the marker, such as, but not limited to, one or more inputs to indicate an amount of funds to be accessed via the marker, one or more inputs to approve the indicated amount of funds to be accessed via the marker, and/or one or more inputs to confirm the accessing of the marker.

In certain embodiments, following the approval of a marker, to request a transfer of an amount of funds via the marker to the gaming establishment device, a user utilizes a physical instrument (e.g., a smart card or a user issued magnetic striped card which the user utilizes via inserting the card into a card reader associated with the gaming establishment device) to enable the user to identify themselves to the gaming establishment device (and the gaming establishment credit system) and interfaces with the gaming establishment device (or a component associated with the gaming establishment device) to request an electronic transfer of funds from the gaming establishment credit system to the gaming establishment device.

In certain embodiments, following the approval of a marker, to request a transfer of an amount of funds via the marker to the gaming establishment device, the system requires the user to pair a mobile device with the gaming establishment device. For example, to access an amount of funds via a marker, the system requires the user to pair a mobile device (which is executing a gaming establishment mobile device application) with a SMIB (i.e., a component of the gaming establishment patron management system) associated with the EGM and interface with at least the mobile device application to request an electronic transfer of funds from the gaming establishment credit system to the gaming establishment device.

In certain embodiments, the pairing between a mobile device and a component of a gaming establishment patron management system associated with a gaming establishment device is accomplished by one or more wireless communication protocols between the mobile device and the component of the gaming establishment patron management system associated with a gaming establishment device (or the gaming establishment device itself). In certain embodiments, the communication with the mobile device can occur through one or more wireless interfaces of the gaming establishment device (described herein as an EGM but not otherwise limited to an EGM) and/or the component of the gaming establishment patron management system (described herein as a SMIB but not otherwise limited to a SMIB) associated with the gaming establishment device.

In one embodiment, the wireless interface is integrated into a device mounted to and/or within the EGM cabinet, such as a SMIB associated with a card reader or a player tracking unit. In another embodiment, the wireless interface is integrated into the cabinet of the EGM and the EGM processor is configured to communicate directly with and send control commands to the wireless interface. In certain embodiments where the wireless interface is embedded in a secondary device, such as a SMIB, the EGM processor sends control commands to control the wireless interface via a secondary controller.

In certain embodiments, the wireless interface implements one or more wireless communication protocols including, but not limited to: Bluetooth™, Bluetooth™ Low Energy (“BLE”), one or more cellular communication standards (e.g., 3G, 4G, 5G, 6G, LTE), and/or one or more Wi-Fi compatible standards to facilitate the pairing between the mobile device and the SMIB (and/or the EGM) to enable a transfer of funds via the marker to the EGM.

In certain such embodiments, Bluetooth™ pairing occurs when two Bluetooth devices agree to communicate with each other and establish a connection. In order to pair two Bluetooth wireless devices, a password (passkey) is exchanged between the two devices. The Passkey is a code shared by both Bluetooth devices, which proves that both users have agreed to pair with each other. After the passkey code is exchanged, an encrypted communication can be set up between the pair devices. In Wi-Fi paring, every pairing can be set up with WPA2 encryption or another type of encryption scheme to keep the transfer private. Wi-Fi Direct is an example of a protocol that can be used to establish point-to-point communications between two Wi-Fi devices. The protocol enables for a Wi-Fi device pair directly with another without having to first join a local network. In such embodiments, utilizing a Wi-Fi/Bluetooth™ communications protocol implementation, the mobile device communicates with the SMIB (and/or the EGM) via a Wi-Fi/Bluetooth™ communications protocol.

In certain embodiments which implement a wireless communication protocol, such as a Wi-Fi, cellular and/or Bluetooth™ communication protocol, the system utilizes one or more QR codes to facilitate the communication of data between the mobile device and the SMIB (and/or the EGM). In such embodiments, the QR code is used to identify the SMIB, the EGM and/or a server to which the mobile device should connect. In certain embodiments, the QR code enables the establishment of a secure tunnel or path from the mobile device to the gaming establishment's Wi-Fi network and then to the gaming establishment's wired network and finally to the SMIB (and/or the EGM). In these embodiments, a communication tunnel wrapper (e.g., a Wi-Fi/Bluetooth™ tunnel wrapper) is utilized to establish a connection between the SMIB (and/or the EGM and/or a server associated with the SMIB or associated with the EGM) and the mobile device and to transport any data messages between the SMIB (and/or the EGM and/or a server associated with the SMIB or associated with the EGM) and the mobile device.

In certain embodiments, the QR code comprises a static QR code, such as a sticker or metallic plate affixed to the EGM. In certain such embodiments, the QR code uniquely identifies the particular SMIB (and/or the EGM) directly or indirectly, such as representing a value in a database that is associated with that particular SMIB (and/or that particular EGM). In certain embodiments, the QR code comprises a dynamic QR code that is displayed by a display device associated with the SMIB (and/or the EGM), such as a QR code displayed by a service window. In these embodiments, a user requests, via an input at the SMIB, the EGM and/or the mobile device, the generation of a QR code. In response to the request, the SMIB or the EGM displays a QR code. Such an on-demand QR code remains valid for a designated amount of time such that if the user does not scan the QR code within the designated amount of time, another QR code is necessary to be scanned to connect the mobile device to the SMIB (and/or the EGM). For example, a QR code is displayed for thirty seconds after which the QR code is no longer displayed. In this example, if another user attempts to scan the QR code after this thirty second window, that other user would need to request, via an input at the SMIB or the EGM, the generation of another separate QR code. As such, to avoid the QR code displayed in association with a given EGM from always have the same data embedded in it because an intruder could scan the QR code and then try to login an hour later to that same EGM, the system requires the user to engage a button on the SMIB or the EGM to display the QR code. This engagement triggers a new QR code that has a unique nonce in it which prevents a third-party (e.g., another user) from sniping information utilized to facilitate the transfer of funds via the marker to the EGM.

In certain embodiments, a user scans a QR code with the mobile device application. If the system determines that the QR code is valid (i.e., not expired), the mobile device application will connect to one or more components of the system, such as the SMIB, the EGM and/or a server operable to identify the SMIB or the EGM. For example, when the mobile device connects to a scalable server, a validation occurs of the nonce scanned and presented to the scalable server. In this example, only if the nonce matches will the system enable the connection. It should be appreciated that as long as the established connection between the mobile device and the system remains active, one or more servers and mobile device may communicate data, such as status updates, as necessary. It should be further appreciated that in association with the wireless communications protocol that employ a QR code, any action requested by the user via the mobile device application does not require a new engagement between the mobile device and the SMIB or the EGM, such as a new scanning of the QR code to send such a requested action from the mobile device to the SMIB, to the EGM and/or to one or more servers and then from one or more servers to the SMIB or the EGM.

In certain embodiments, the wireless interface implements an NFC protocol to facilitate the pairing of the mobile device with the SMIB (and/or the EGM) to enable the transfer of funds via the marker to the EGM. NFC is typically used for communication distances of four cm or less. NFC enables for transactions, data exchange, and connections with a touch. NFC's short range helps keep encrypted identity documents private. As such, a tap of a mobile device with an NFC chip to an EGM can cause a pairing between the SMIB (and/or the EGM) and the mobile device.

Specifically, utilizing an NFC implementation, a mobile device communicates with the SMIB (and/or the EGM) via an NFC protocol. In such embodiments which utilize the NFC implementation, the mobile device application registers a mobile device application with one or more processors of the mobile device. When the mobile device is detected by an NFC reader of or otherwise associated with the SMIB located inside the EGM (and/or the EGM), the SMIB communicates one or more data messages to the mobile device (and/or to one or more servers which then communicate such data messages to the mobile device). Such data messages are commands generated by the SMIB (and/or the EGM) when the mobile device is detected in the NFC reader field. The processor of the mobile device communicates the data message to the registered mobile device application. The mobile device application responds, such as communicating a triggering message, and a communication channel is opened between the SMIB (and/or the EGM) and the mobile device application (or between the SMIB, the EGM, and/or one or more servers and the mobile device application). This open communication channel enables the SMIB (and/or the EGM) to send, though the NFC reader, additional data messages to the mobile device (or to the mobile device via one or more servers) which are responded to by the mobile device application of the mobile device. It should be appreciated that as long as the mobile device remains within the NFC field, the SMIB (and/or the EGM) is configured to communicate with the mobile device and send data, such as status updates, as necessary. However, once the mobile device is removed from the NFC field, the communication channel is closed and such status updates must be discontinued.

It should be appreciated that Wi-Fi, cellular, Bluetooth™, BLE communication protocols can be used in lieu of or in combination with NFC. For instance, an NFC communication can be used to instantiate a Wi-Fi or Bluetooth™ communication between the SMIB, the EGM, and/or zero, one or more servers and a mobile device, such as secure pairing using one of these protocols. That is, in one embodiment, an NFC interface can be used to set-up a higher speed communication with the NFC enabled mobile device. The higher speed communication rates can be used for expanded content sharing. For instance, a NFC and Bluetooth enabled EGM can be tapped by an NFC and Bluetooth enabled mobile device for instant Bluetooth pairing between the devices and zero, one or more servers. Instant Bluetooth pairing between an EGM, an NFC enabled mobile device and zero, one or more servers, can save searching, waiting, and entering codes. In another example, an EGM can be configured as an NFC enabled router, such as a router supporting a Wi-Fi communication standard. Tapping an NFC enabled mobile device to an NFC enabled and Wi-Fi enabled EGM can be used to establish a Wi-Fi connection between the devices and zero, one or more servers.

In certain embodiments which utilize one or more of the communication protocols described herein, any action requested by the user via the mobile device application requires a new engagement between the mobile device and the SMIB (and/or the EGM), such as a new tap of the mobile device to a designated location of the EGM. In certain other embodiments which utilize one or more of the communication protocol described herein, certain actions requested by the user via the mobile device application requires a new engagement between the mobile device and the SMIB (and/or the EGM), such as a new tap of the mobile device to a designated location of the EGM and other actions requested by the user via the mobile device application do not require any new engagement between the mobile device and the SMIB (and/or the EGM).

In certain embodiments, following receipt of the user inputted data associated with the determined amount of funds to be accessed via the marker and a confirmation from the user that they approve of the transaction and agree to any terms associated with the marker transaction, the system communicates one or more messages to the gaming establishment credit system to log the user into the gaming establishment credit system (if necessary) and request an activation of the amount of funds to be accessed via the marker of the user. Upon receiving the messages and verifying the request, the gaming establishment credit system proceeds with operating with the gaming establishment fund management system (e.g., a gaming establishment cashless wagering system) to log the user into a gaming establishment account (described herein as a cashless wagering account but not otherwise limited to a cashless wagering account) associated with the user (if necessary) and potentially transfer the amount of funds to be accessed via the marker to the gaming establishment account associated with the user (e.g., to a gaming establishment cashless wagering account associated with the user.)

In certain embodiments, to complete a transfer of an amount of funds accessed via a marker to a gaming establishment account, the gaming establishment credit system determines whether to authorize the activation of the determined amount of funds. In these embodiments, if the gaming establishment credit system determines not to authorize the activation of the determined amount of funds via the marker, the gaming establishment credit system communicates one or more denial messages. In certain embodiments, following the denial, one or more display devices (e.g., display devices of a mobile device and/or the EGM) display a denial of marker activation to the user.

On the other hand, if the gaming establishment credit system determines to authorize the activation of the determined amount of funds via the marker, the gaming establishment credit system updates the amount provided via the marker and communicates an authorization of the requested amount of funds to the gaming establishment fund management system. Upon receiving the authorization, the gaming establishment fund management system updates a balance of a gaming establishment account by the requested amount of funds activated via the marker. In certain embodiments, in association with the transfer, the system communicates a transfer of funds confirmation, wherein one or more display devices display a confirmation of the transfer of the amount of funds from the marker to the gaming establishment account.

In certain embodiments, in association with the activation of an amount of funds via a marker, the system (e.g., the gaming establishment credit system) logs certain data associated with such an activation in one or more durable stores, such as one or more relational databases, to enable the subsequent accounting and/or auditing of such a transaction. In certain such embodiments, the system logs data associated with the marker activation in a marker transaction store that holds records of one or more marker transactions activated in association with one or more EGMs.

In certain embodiments, following the completion of the transfer of an amount of funds associated with the marker to the gaming establishment account, such as a cashless wagering account associated with a user, the system enables the user to transfer an amount of funds from the gaming establishment account to the EGM. In certain other embodiments, following the completion of the transfer of an amount of funds associated with the marker to the gaming establishment account, such as a cashless wagering account associated with a user, the system automatically initiates a transfer of an amount of funds from the gaming establishment account to the EGM. In these embodiments, rather than the user making one or more inputs to attempt to transfer the amount of funds accessed via the marker to the EGM, the system automatically determines to transfer an amount of funds, such as the amount accessed via the marker, from the gaming establishment account to the EGM.

In these different embodiments, following a determination to transfer an amount of funds from the gaming establishment account to the EGM, a component of the gaming establishment fund management system, such as a server of the cashless wagering system, logs the user into a gaming establishment account associated with the user (if necessary) and requests the determined amount of funds to be transferred from the gaming establishment account to the EGM. In these embodiments, the component of the gaming establishment fund management system, such as a server of the cashless wagering system, determines whether to authorize the transfer of the amount of funds. If the component of the gaming establishment fund management system determines not to authorize the determined amount of funds, the component of the gaming establishment fund management system communicates a denial and, in certain embodiments, displays a denial of funds transfer to the user. On the other hand, if the component of the gaming establishment fund management system determines to authorize the amount of funds, the component of the gaming establishment fund management system updates the gaming establishment account associated with the user and communicates an authorization to the SMIB (and/or the EGM). For example, when funds are transferred from a cashless wagering account to the EGM, the cashless wagering system reduces a balance of the cashless wagering account by the reduced amount of funds. The EGM proceeds with updating a credit balance of the EGM to account for the amount of funds. In certain embodiments, the EGM further proceeds with communicating a transfer of funds confirmation and such a transferred amount of funds is then available for wagering at the EGM.

It should be appreciated that in addition to transferring funds activated via a marker from a gaming establishment credit system to a gaming establishment account and then to a gaming establishment device, such as an EGM, the system enables a transfer of funds from a gaming establishment device, such as an EGM, to a gaming establishment account and then to the gaming establishment credit system to payback or otherwise deactivate a marker.

In certain embodiments, following the use of none, part or all of the transferred amount of funds at the EGM from an activated marker and upon receiving a “cash out” input from the user, part or all of the credit balance of the EGM is transferred to the gaming establishment account independent of any attempt to repay the amount of funds outstanding on any activated markers. In these embodiments, unlike prior systems which required that any amount cashed out from an EGM is automatically applied to repay the amount of funds outstanding on any activated markers, the system of certain embodiments does not mandate that any amount cashed out from an EGM is automatically applied to repay the amount of funds outstanding on any activated markers. Rather, after an amount of funds are cashed out from an EGM, the system enables such cashed out funds to flow to a gaming establishment account, such as a cashless wagering account, thereby reducing user tension by not having to continually activate the marker at each EGM played.

In certain embodiments, following one or more inputs to cash out a credit balance of an EGM to a gaming establishment account, the SMIB (and/or the EGM) operates with the gaming establishment fund management system to transfer the amount of funds of the credit balance of the EGM to the gaming establishment account, such as the cashless wagering account associated with the user. In certain other embodiments, the system determines to facilitate the transfer of funds from the EGM to the gaming establishment account, such as the cashless wagering account, independent of any input by the user. In one such embodiment, if the system determines that no activity has occurred for a designated amount of time, as a precautionary measure, the system automatically transfers the credit balance of the EGM from the EGM to the gaming establishment account used to transfer funds to the EGM. In another embodiment, if the system determines that another user is attempting to log onto the EGM, as a precautionary measure, the system automatically transfers the credit balance of the EGM from the EGM to the gaming establishment account used to transfer funds to the EGM.

In these embodiments, after a determination to transfer the credit balance of the EGM from the EGM to a gaming establishment account, the SMIB (and/or the EGM) proceeds with operating with the gaming establishment fund management system to log the player into a gaming establishment account, such as a cashless wagering account associated with the user (or confirm that the user remains logged into the gaming establishment account) and request the determined amount of funds to be transferred from the EGM to the gaming establishment account. Following such a request, the EGM proceeds with updating a credit balance of the EGM to account for the determined amount of funds transferred from the EGM to the gaming establishment account. The gaming establishment fund management system additionally updates the gaming establishment account associated with the user (e.g., the cashless wagering system adds the determined amount of funds to the cashless wagering account) and communicates a confirmation to the SMIB (and/or the EGM). Such a transferred amount of funds are available in the gaming establishment account to be transferred to another gaming establishment device (such as another EGM or a gaming table component) or another gaming establishment account.

In certain embodiments, in association with the transfer of funds to and/or from a gaming establishment account, the system (e.g., the gaming establishment fund management system, such as the cashless wagering system) logs certain data associated with such a transfer in one or more durable gaming establishment account stores, such as one or more relational databases, to enable the subsequent accounting and/or auditing of such transactions occurring in association with that gaming establishment account. In certain such embodiments, the system logs data associated with the electronic funds transfers in a cashless wagering account transaction store that holds records of one or more transfers of funds to/from one or more cashless wagering accounts.

It should be appreciated that since the amount of funds of the credit balance of the EGM are not necessarily utilized to pay back any outstanding markers but are transferred from the EGM to a gaming establishment account, the system of the present disclosure reduces friction for the user (i.e., the user does not need to repeatedly reactivate the same marker) and promotes the user transitioning from one EGM to another without having to reactivate funds from their marker (which remain accessible in their gaming establishment account, such as their cashless wagering account). Additionally, by not requiring the automatic repayment of a marker with each and every cash out from an EGM, the system enables the user to make a second withdrawal from the marker without having to satisfy the first withdrawal, thereby providing the user greater control over the funds represented by what is owed on the marker.

In certain embodiments, the system enables the user to utilize part or all of the funds transferred to the gaming establishment account to repay the amount owed on the activated marker. In certain other embodiments, responsive to one or more marker repayment events, the system automatically utilizes part or all of the funds transferred to the gaming establishment account to repay the amount owed on the activated marker. In these embodiments, after a determination to repay part or all of an amount owed on an activated marker, the gaming establishment fund management system operates with the gaming establishment credit system to request an amount of funds to be transferred from the gaming establishment account to the gaming establishment credit system to satisfy part or all of an activated marker. Following such a request (and an approval by the gaming establishment credit system), the gaming establishment fund management system updates the gaming establishment account associated with the user (e.g., the cashless wagering system subtracts the determined amount of funds from the cashless wagering account) and the gaming establishment credit system updates the repayment of the amount owed on the activated marker. In these embodiments, if the marker is paid back in full, the gaming establishment credit system deactivates or retires the marker. On the other hand, if the marker is not paid back in full, the gaming establishment credit system maintains the activated marker and updates the balance owed on the marker.

In certain embodiments, in association with the repayment of an amount of funds from a marker and/or the deactivation of a marker repaid in full, the system (e.g., the gaming establishment credit system) logs certain data associated with such transactions in one or more durable stores, such as one or more relational databases, to enable the subsequent accounting and/or auditing of such transactions. In certain such embodiments, the system logs data associated with the marker repayment and/or the marker deactivation in a marker transaction store that holds records of one or more marker transactions.

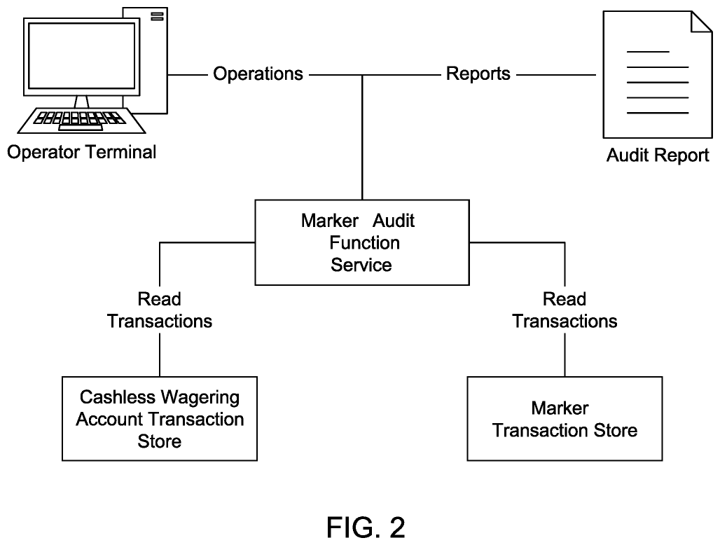

In certain embodiments, different databases are separately and distinctly maintained by different entities (each of which may be individually associated with or independent of any component of the system of the present disclosure) such that one or more components of the system interface with these different entities to access these databases to undertake certain activities such as, but not limited to, read data from these databases, perform audits based on data from these databases and/or generate reports based on data from these databases. For example, as seen in FIG. 2, one or more servers operating as the marker audit function service interfaces with one or more servers that maintain the marker transaction store to read data relating to marker transactions and further interfaces with one or more servers that maintain the cashless wagering account transaction store to read data relating to the cashless wagering account transaction. As seen in FIG. 2, the marker audit function service interfaces with an operator terminal to receive commands, such as to generate one or more audit reports based on the data retrieved by the marker audit function service.

It should be appreciated that in certain embodiments in which different databases are separately and distinctly maintained by different entities, the system provides the marker audit function service access to the various stores or provides a copy of the required data to the marker audit function service. For example, as seen in FIG. 1B, since the cashless wagering system maintains the cashless wagering account transaction store and the marker service maintains the marker transaction store, the system provides the marker audit function service access to each of these stores (or provides a copy of the required data from one or more of these stores) to enable the marker audit function service to perform various audit functions. In certain such embodiments, access to the data could be via an SQL Server linked database server that provides a communication path for one database querying the data of another database as if they are one instance of a database. In these embodiments, once the data is query-able, the marker audit function service can perform one or more audit functions against the data and cause one or more reports to be generated. In certain other embodiments, the system copies (or causes a copy) of the required data from one store to another store such that the marker audit function service can access the data directly.

In certain embodiments, the system obtains data from one or more transaction stores to audit transactions recorded in such transaction stores and potentially adjust certain data if warranted. In one such embodiment, the system (e.g., one or more servers operating as the marker audit function service) extracts data from a gaming establishment account transaction store (e.g., a cashless wagering account transaction store that holds records of one or more electronic funds transfers to/from one or more cashless wagering accounts), and further extracts data from the marker transaction store (that holds records of one or more marker transactions). In certain embodiments, the system (e.g., one or more servers operating as the marker audit function service) accesses data held in the gaming establishment account transaction store by calling one or more application programming interfaces of the gaming establishment account transaction store or remotely accessing the gaming establishment account transaction store. In certain embodiments, the system (e.g., one or more servers operating as the marker audit function service) additionally or alternatively accesses data held in the marker transaction store by calling one or more application programming interfaces of the marker transaction store or remotely accessing the marker transaction store. In these different embodiments, following the retrieval of such data, the system (e.g., one or more servers operating as the marker audit function service) reconciles this data to determine if any discrepancies or variances exist.

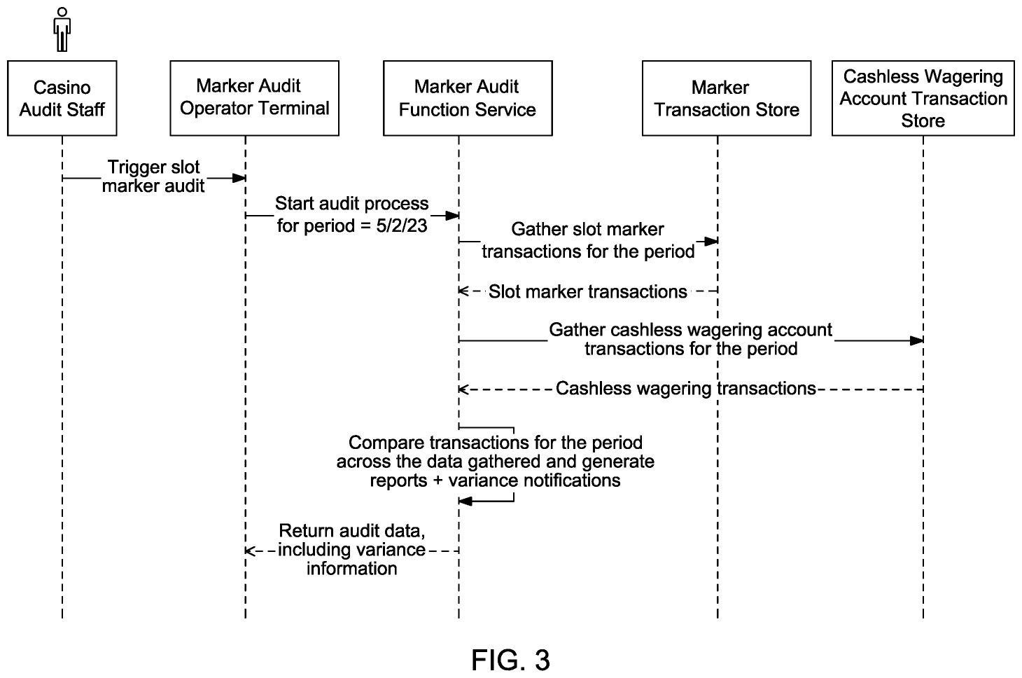

In different embodiments, the data retrieved from one or more transaction stores includes, but is not limited to, historic transaction data for an identified user, historic transaction data for an identified user over a selected period, historic transaction data for an identified EGM, historic transaction data for an identified EGM over a selected period, historic transaction data for an identified gaming establishment account, historic transaction data for an identified gaming establishment account over a selected period and/or historic transaction data for a selected period. For example, as seen in FIG. 3, following a request, via a marker audit operator terminal, for a marker audit triggered by gaming establishment personnel (e.g. casino accounting staff), part or all of the transaction data for an audited period of time from a marker transaction store are communicated to one or more servers operating as the marker audition function service. In this example, part or all of transaction data for the audited period of time from a gaming establishment account transaction store are also communicated to the one or more servers operating as the marker audition function service. In this example, the marker audit function service compares such transaction data to determine any variances and generates an audit report including any variance information.

In certain embodiments, the different databases are maintained by a single entity to enable the marker audit function service direct access to the stored data (without having to interface with different entities) to undertake certain activities such as, but not limited to, read data from these databases, perform audits based on data from these databases and/or generate reports based on data from these databases. In such embodiments in which the different datasets are maintained by a single entity, since the marker audit function service has direct access to the stored data from each of the marker transaction store (that holds records of one or more marker transactions) and the gaming establishment account transaction store (e.g., a cashless wagering account transaction store that holds records of one or more transfers of funds to/from one or more cashless wagering accounts), the marker audit function service can perform one or more audit functions against that data.

In certain embodiments, in addition to (or alternative from) enabling the system (e.g., one or more servers operating as a marker audit function service) to audit marker transactions relative to transactions involving the transfer of funds to/from one or more cashless wagering accounts and reporting on that data, the system enables a third-party auditing and reporting system to access the data for independent auditing purposes. In these embodiments, to support third-party auditing, the various data stores expose application programming interfaces (or other mechanisms) to enable third-party auditing systems to query and receive data from the different transaction stores such that the third-party may audit the data associated with such marker transactions relative to transactions involving the transfer of funds to/from one or more cashless wagering accounts. In different embodiments, the data can be queried on an ad hoc basis by the third-party audit system, the data can be queried on varying granular levels, such as by data for a particular user and/or by all data of all transactions over a requested period of time. In another embodiment, the system communicates part or all of the data of the marker transactions relative to transactions involving the transfer of funds to/from one or more cashless wagering accounts to the third-party audit system as part of a subscription, such that the third-party audit system receives the data as soon as it is created in the audit system. In this embodiment, the system utilizes an enterprise service bus, such as RabbitMQ, and a subscription to the service bus to enable such reporting of data of the marker transactions.

In certain embodiments, to audit data associated with a marker transaction store (that holds records of one or more marker transactions) and data associated with a gaming establishment account transaction store (e.g., a cashless wagering account transaction store that holds records of one or more transfers of funds to/from one or more cashless wagering accounts), the marker audit function service compares the transaction data between the different transaction stores to determine if the transactions correspond to each other (e.g., are any transactions associated with a marker from the marker transaction store unverifiable against a transaction associated with the flow of funds from the cashless wagering account transaction store in association with that marker).

In certain embodiments, to facilitate the marker audit, the system (e.g., one or more servers operating as the marker audit function service) compares the transactions totals (and/or per transaction details) recorded in one maintained transaction store or database with the summed-up totals (and/or per transaction details) recorded in the other transaction store or database. For example, to compare the totals across both transaction stores, the system employs the formula of

$${\sum }_{n = 1}^{∞} {transactionAmount}_{n} .$$

It should be appreciated that in certain embodiments in which the system audits purely based on total amounts of transactions for a certain period of time, if the totals do not match for that period, it may be difficult to determine where the error occurred and/or any other underlying issues associated with the total amount of transactions not corresponding from one database to another database for that period of time. As such, in certain embodiments, the system undertakes a more granular approach to the marker audit. In one such embodiment in conducting the marker audit, the system calculates the totals on a per cashless wagering account and marker account basis such that if a variance occurs, the system associates the variance (or other underlying issue) with a specific cashless wagering account/specific marker account which enables gaming establishment personnel to further investigate into that identified issue. In another such embodiment of conducting the marker audit, the system calculates the totals on a per user basis such that if a variance occurs, the system associates the variance (or other underlying issue) with a specific user which enables gaming establishment personnel to further investigate into that identified issue. In another such embodiment of conducting the marker audit, the system calculates the totals on a per EGM basis such that if a variance occurs, the system associates the variance (or other underlying issue) with a specific EGM which enables gaming establishment personnel to further investigate into that identified issue. In another such embodiment of conducting the marker audit, the system calculates the totals employing multiple factors such as a per user basis coupled with a per EGM basis such that if a variance occurs, the system associates the variance (or other underlying issue) with a specific user and a specific EGM which enables gaming establishment personnel to further investigate into that identified issue. It should be appreciated that when the marker audit is conducted in association with a specific EGM, since a marker is not necessarily automatically paid back when a cashout event occurs at an EGM (but instead is paid back, manually at a later point in time or automatically at a later point in time, independent of the cashout event), such a subsequent pay back transaction would not be associated with the EGM and thus the transactions of the different transaction stores may not align for a given period of time.

It should be further appreciated that when accounting for instances of timing inconsistences associated with when funds accessed from a marker are transferred from a gaming establishment account to a gaming establishment account relative to when any amounts owed against that marker are paid back, since funds associated with an activated marker flow to a gaming establishment account and then from the gaming establishment account to pay back the marker, when the transaction totals for one or more gaming establishment accounts are added up for a reporting period, that total should match the marker totals for the same reporting period. Against this expectation of matching totals, if the system (e.g., one or more servers operating as marker audit function service) compares the results of the calculations made based on the data accessed from the marker transaction store and the gaming establishment account transaction store and determines that the total over a reporting period do not match, the system flags or otherwise notes such a discrepancy or variance in the audit report. Such flagging of any variance enables the operator to further inspect the data to try to understand, and potentially correct, the variance. That is, if one or more discrepancies or variances are flagged, such variances are investigated to determine if the variance leads to further actions (e.g., any adjustments to the marker issuance protocol, and/or any adjustments to the audit process) or if the variance is the result of legitimate circumstances.

In certain instances, one or more variances are expected and do not suggest any nefarious activity, such as when a marker is paid back independent of the flow of funds to/from a gaming establishment account, such as a cashless wagering account. In these instances, the system (e.g., one or more servers operating as marker audit function service) includes one or more ways to correct such variances by adjusting certain data or adding certain data. One such embodiment includes the system directly changing the balance of the gaming establishment account (e.g., cashless wagering account) that is causing the variance. One such embodiment includes the system directly changing the amount of funds associated with the outstanding marker that is causing the variance. Another such embodiment includes enabling an operator to create a new type of record, such as a marker adjustment record, that will be included in the audit calculations. Such a new record includes a time period identifier, and an amount for the adjustment (which may be a positive or negative number), an indicator of an identity of the operator creating the adjustment and a free form notes field for the operator to explain the need for the adjustment. In performing the above-described audit calculations, the system adjusts for this new record.

In certain other instances, one or more variances are unexpected and suggest nefarious activity that warrants further attention. That is, since various discrepancies or variances between marker data and gaming establishment account transfer data may be the result of legitimate circumstances, certain malicious gaming establishment personnel may aim to take advantage of these discrepancies perceived as being the result of legitimate circumstances to avoid the investigations of gaming establishment accountants and/or certain authorities. For example, if funds are being manufactured in association with markers and gaming establishment account transfers that do not match up, the audit report generated would include a variance associated with such activity which may warrant further investigation (and potential action) by the operator (e.g., a member of gaming establishment accounting staff) and/or third-parties (e.g., law enforcement authorities). Such investigation and/or any undertaken prohibitive measures associated with the system of the present disclosure minimize (or eliminate) certain potential embezzlement activities.

Accordingly, since the activation of a gaming establishment marker at an EGM includes a transfer of funds from a gaming establishment credit system to a gaming establishment account maintained by a gaming establishment fund management system and then a transfer of such funds from the gaming establishment account to the EGM, the system employs a distinct marker audit function service to audit funds transferred in association with the activation of the gaming establishment marker and reconcile such funds against transactions recorded by the gaming establishment credit system and the gaming establishment fund management system. For example, since the activation of a marker at an EGM involves funds associated with the marker first being transferred to a cashless wagering account and then being transferred to the EGM, the system accesses one or more databases to determine zero, one or more transactions associated with the cashless wagering account and zero, one or more transactions associated with the gaming establishment credit system and audits such transactions to determine whether or not the transactions associated with the cashless wagering account track the transactions associated with the gaming establishment credit system. As such, since the activation of a gaming establishment marker at an EGM results in an amount of funds flowing through one or more intermediate destinations before being transferred to the EGM, the system independently audits these marker transfers to determine if any discrepancies or variances exist between different data sets associated with these different transactions. Moreover, if such discrepancies exist, the system determines one or more available actions to cure such a discrepancy and/or report such discrepancies to certain interested parties (whom may take further action if such discrepancies are indicative of nefarious activity).

It should be appreciated that the marker activation transfers of the present disclosure may occur in addition to or as an alternative from cash-based fund transfers and/or cashless ticket voucher-based fund transfers. It should be further appreciated that any functionality or process of the present disclosure may be implemented via one or more servers (associated with or independent of any component of any system disclosed herein), a mobile device application, one or more gaming establishment devices (e.g., a gaming device such as an EGM or a non-gaming device such as a point-of-sale terminal of a retailer located within or otherwise associated with a gaming establishment), and/or one or more components of a gaming establishment system (such as a component of a gaming establishment patron management system supported by or otherwise located inside a gaming establishment device and/or a non-gaming establishment device). Accordingly: (i) while certain functions, features or processes are described herein as being performed by one (or more) device (e.g., a server, a mobile device application, a gaming establishment device, a component of a gaming establishment system), such functions, features or processes may alternatively be performed, if applicable, by another such different devices.

In certain embodiments, the above-described embodiments of the present disclosure may be implemented in accordance with or in conjunction with zero, one or more components of the system (e.g., a payment gateway, an electronic funding service and/or a marker audit function service); zero, one or more components of a gaming establishment system (e.g., an operator terminal, a gaming establishment patron management system, a gaming establishment fund management system, and/or a gaming establishment device management system) and/or zero, one or more gaming establishment devices. In these embodiments, such a component of the system, component of the gaming establishment system, and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the system, the component of the gaming establishment system, and/or the gaming establishment device; (3) accessing memory to configure or reconfigure parameters in the memory according to indicia read from the component of the system, the component of the gaming establishment system, and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the system, the component of the gaming establishment system, and/or the gaming establishment device, while in other embodiments, at least one component of the controller resides outside of the housing of the component of the system, the component of the gaming establishment system, and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the system, the component of the gaming establishment system, and/or the gaming establishment device disclosed herein. In certain embodiments, the at least one memory device resides within the housing of the component of the system, the component of the gaming establishment system, and/or the gaming establishment device, while in other embodiments at least one component of the at least one memory device resides outside of the housing of the component of the system, the component of the gaming establishment system, and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the system, the component of the gaming establishment system, and/or the gaming establishment device; (2) associations between configuration indicia read from the component of the system, the component of the gaming establishment system, and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the system, the component of the gaming establishment system, and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the system (e.g., a payment gateway, an electronic funding service and/or a marker audit function service), the component of the gaming establishment system, and/or the gaming establishment device to control the component of the system, the component of the gaming establishment system, and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) uses such a removable memory device in a component of the gaming establishment fund management system to implement at least part of the present disclosure. In other embodiments, part or all of the program code and/or the operating data is downloaded to the at least one memory device of the component of the system, the component of the gaming establishment system, and/or the gaming establishment device through any suitable data network described above (such as an Internet or intranet).

The at least one memory device also stores a plurality of device drivers. Examples of different types of device drivers include device drivers for the component of the system, the component of the gaming establishment system, and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the system, the component of the gaming establishment system, and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the system, the component of the gaming establishment system, and/or the gaming establishment device loads the new device driver from the at least one memory device to enable communication with the new device. For instance, one type of card reader in the component of the system, the component of the gaming establishment system, and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the system (e.g., a payment gateway, an electronic funding service and/or a marker audit function service), components of the gaming establishment system, and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the system, the component of the gaming establishment system, and/or the gaming establishment device. For example, the display devices serve as digital glass configured to display aspects of the gaming establishment device. In various embodiments, the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. For example, after the gaming establishment device receives an actuation, the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. For example, the gaming establishment device provides dynamic sounds coupled with attractive multimedia images displayed on one or more of the display devices to provide an audio-visual representation or to otherwise display full-motion video with sound to attract users to the gaming establishment device. In certain embodiments, the gaming establishment device displays a sequence of audio and/or visual attraction messages during idle periods to attract potential users to the gaming establishment device. The videos may be customized to provide any appropriate information.

The at least one input device may include any suitable device that enables an input signal to be produced and received by the at least one processor of the component of the system, the component of the gaming establishment system, and/or the gaming establishment device. In one embodiment, the at least one input device includes a payment device configured to communicate with the at least one processor of the gaming establishment device to fund the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the gaming establishment device to be funded via an electronic funds transfer, such as a transfer of funds from a bank account. In another embodiment, the gaming establishment device includes a payment device configured to communicate with a mobile device of a user, such as a mobile phone, a radio frequency identification tag, or any other suitable wired or wireless device, to retrieve relevant information associated with that user to fund the gaming establishment device. When the gaming establishment device is funded, the at least one processor determines the amount of funds entered and displays the corresponding amount.

In various embodiments, the at least one input device includes a plurality of buttons that are programmable by the component of the system, the component of the gaming establishment system, and/or the gaming establishment device operator to, when actuated, cause the component of the system, the component of the gaming establishment system, and/or the gaming establishment device to perform particular functions. For instance, such buttons may be hard keys, programmable soft keys, or icons icon displayed on a display device of the gaming establishment device that are actuatable via a touch screen of the gaming establishment device or via use of a suitable input device of the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the system, the component of the gaming establishment system, and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the system, the component of the gaming establishment system, and/or the gaming establishment device, such as one or more rechargeable power sources (e.g., rechargeable batteries) located at the component of the system, the component of the gaming establishment system, and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the system, the component of the gaming establishment system, and/or the gaming establishment device; detecting the presence and/or identity of various persons (e.g., users, casino employees, etc.), devices (e.g., user input devices), and/or systems within a predetermined proximity to the component of the system, the component of the gaming establishment system, and/or the gaming establishment device.

The at least one data preservation component is configured to detect or sense one or more events and/or conditions that, for example, may result in damage to the component of the system, the component of the gaming establishment system, and/or the gaming establishment device and/or that may result in loss of information associated with the component of the system, the component of the gaming establishment system, and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the system, the component of the gaming establishment system, and/or the gaming establishment device to operate in a mobile environment.

The at least one geolocation module is configured to acquire geolocation information from one or more remote sources and use the acquired geolocation information to determine information relating to a relative and/or absolute position of the component of the system, the component of the gaming establishment system, and/or the gaming establishment device. For example, in one implementation, the at least one geolocation module is configured to receive GPS signal information for use in determining the position or location of the gaming establishment device. In another implementation, the at least one geolocation module is configured to receive multiple wireless signals from multiple remote devices and use the signal information to compute position/location information relating to the position or location of the gaming establishment device.

The at least one user identification module is configured to determine the identity of the current user or current owner of the component of the system, the component of the gaming establishment system, and/or the gaming establishment device. For example, in one embodiment, the current user is required to perform a login process at the component of the system, the component of the gaming establishment system, and/or the gaming establishment device in order to access one or more features. Alternatively, the component of the system, the component of the gaming establishment system, and/or the gaming establishment device is configured to automatically determine the identity of the current user based on one or more external signals, such as an RFID tag or badge worn by the current user and that provides a wireless signal to the component of the system, the component of the gaming establishment system, and/or the gaming establishment device that is used to determine the identity of the current user. In at least one embodiment, various security features are incorporated into the component of the system, the component of the gaming establishment system, and/or the gaming establishment device to prevent unauthorized users from accessing confidential or sensitive information.

The at least one information filtering module is configured to perform filtering (e.g., based on specified criteria) of selected information to be displayed at one or more displays of the component of the system, the component of the gaming establishment system, and/or the gaming establishment device.

In various embodiments, the component of the system, the component of the gaming establishment system, and/or the gaming establishment device includes a plurality of communication ports configured to enable the at least one processor of the component of the system, the component of the gaming establishment system, and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the system, the component of the gaming establishment system, and/or the gaming establishment device has a support structure, housing, or cabinet that provides support for a plurality of the input devices and the output devices of the component of the system, the component of the gaming establishment system, and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor following an activation of a marker from a gaming establishment credit system and a transfer of an amount of funds associated with the activated marker to a gaming establishment account maintained by a component of a gaming establishment fund management system, cause the processor to:
generate an audit report based on a comparison of data associated with the activation of the marker and data associated with the transfer of the amount of funds associated with the activated marker to the gaming establishment account, and
responsive to a discrepancy between the data associated with the activation of the marker and the data associated with the transfer of the amount of funds associated with the activated marker to the gaming establishment account, enable an adjustment to resolve the discrepancy.

2. The system of claim 1, wherein the adjustment comprises a modification of the data associated with the activation of the marker.

3. The system of claim 1, wherein the adjustment comprises a modification of the data associated with the transfer of the amount of funds associated with the activated marker to the gaming establishment account.

4. The system of claim 1, wherein the adjustment comprises a creation of data associated with a resolution of the discrepancy.

5. The system of claim 1, wherein the audit report is generated in association with an audit request from an operator terminal.

6. The system of claim 1, wherein the gaming establishment account comprises a cashless wagering account.

7. The system of claim 1, wherein the data associated with the activation of the marker comprises data associated with an identified user over a period of time and the gaming establishment account is associated with the identified user.

8. The system of claim 1, wherein the data associated with the activation of the marker comprises data associated with a gaming establishment device and the data associated with the transfer of the amount of funds associated with the activated marker to the gaming establishment account comprises data associated any transfers of any part of the amount of funds associated with the activated marker from the gaming establishment account to the gaming establishment device.

9. The system of claim 1, wherein the audit report is further based on a comparison of data associated with a repayment of the marker and data associated with a transfer, from the gaming establishment account, of an amount of funds to repay the marker.

10. A system comprising:
a processor; and
a memory device that stores a plurality of instructions that, when executed by the processor following an activation of a marker from a gaming establishment credit system, a first transfer of funds associated with the activated marker to a gaming establishment account maintained by a component of a gaming establishment fund management system and a repayment of the marker based on a second transfer of funds from the gaming establishment account to the gaming establishment credit system, cause the processor to:
generate an audit report based on a comparison of data associated with the marker and data associated with the transfers of funds associated with the gaming establishment account, and
responsive to the audit report comprising a discrepancy based on the comparison, enable an adjustment to resolve the discrepancy.

11. The system of claim 10, wherein the comparison comprises at least one of a per user comparison, a per gaming establishment device comparison and a per gaming establishment account comparison.

12. A method of operating a system, the method comprising:
following an activation of a marker from a gaming establishment credit system and a transfer of an amount of funds associated with the activated marker to a gaming establishment account maintained by a component of a gaming establishment fund management system:
generating, by a processor, an audit report based on a comparison of data associated with the activation of the marker and data associated with the transfer of the amount of funds associated with the activated marker to the gaming establishment account, and
responsive to a discrepancy between the data associated with the activation of the marker and the data associated with the transfer of the amount of funds associated with the activated marker to the gaming establishment account, enabling an adjustment to resolve the discrepancy.

13. The method of claim 12, wherein the adjustment comprises a modification of the data associated with the activation of the marker.

14. The method of claim 12, wherein the adjustment comprises a modification of the data associated with the transfer of the amount of funds associated with the activated marker to the gaming establishment account.

15. The method of claim 12, wherein the adjustment comprises a creation of data associated with a resolution of the discrepancy.

16. The method of claim 12, wherein the audit report is generated in association with an audit request from an operator terminal.

17. The method of claim 12, wherein the gaming establishment account comprises a cashless wagering account.

18. The method of claim 12, wherein the data associated with the activation of the marker comprises data associated with an identified user over a period of time and the gaming establishment account is associated with the identified user.

19. The method of claim 12, wherein the data associated with the activation of the marker comprises data associated with a gaming establishment device and the data associated with the transfer of the amount of funds associated with the activated marker to the gaming establishment account comprises data associated any transfers of any part of the amount of funds associated with the activated marker from the gaming establishment account to the gaming establishment device.

20. The method of claim 12, wherein the audit report is further based on a comparison of data associated with a repayment of the marker and data associated with a transfer, from the gaming establishment account, of an amount of funds to repay the marker.
